(19) United States
(12) Patent Application Publication
(10) Pub. No.: US 2026/0279834 A1
(43) Pub. Date: Sep. 17, 2026

(54) Lithium Secondary Battery

(71) Applicant: Nissan Motor Co., Ltd., Yokohama-shi, Kanagawa (JP)

(72) Inventors: Shotaro Doi, Kanagawa (JP); Hiroaki Yoshitomi, Kanagawa (JP); Yoshitaka Ono, Kanagawa (JP); Shinichi Akaishi, Kanagawa (JP)

(21) Appl. No.: 19/473,333

(22) PCT Filed: Apr. 12, 2023
(86) PCT No.: PCT/JP2023/014819

§ 371 Date: Oct. 7, 2025

(51) Int. Cl. H01M 4/66; H01M 4/02; H01M 4/04; H01M 10/052; H01M 10/0562

(52) U.S. Cl. CPC H01M 4/661; H01M 4/0435; H01M 10/052; H01M 10/0562; H01M 2004/028

(57) ABSTRACT

A means capable of suppressing occurrence of peeling between a solid electrolyte layer and a positive electrode current collector in a lithium secondary battery includes the solid electrolyte layer covering an outer side of a positive electrode active material layer and extending to the positive electrode current collector. In a lithium secondary battery including a solid electrolyte layer covering an outer side of a positive electrode active material layer, a positive electrode current collector has a composite elastic modulus value of 17.0 [GPa] or less as measured by a spherical nanoindentation method for a main surface on a side of the positive electrode active material layer.

### TECHNICAL FIELD

The present invention relates to a lithium secondary battery.

### BACKGROUND ART

In recent years, research and development on an all-solid-state lithium secondary battery using an oxide-based or sulfide-based solid electrolyte as an electrolyte have been actively conducted. The solid electrolyte is a material mainly made of an ion conductor that enables ion conduction in a solid. Therefore, in an all-solid-state lithium secondary battery, in principle, various problems caused by a combustible organic electrolyte solution do not occur unlike the conventional liquid-type lithium ion secondary battery. In general, use of a high-potential and large-capacity positive electrode material and a large-capacity negative electrode material can achieve significant improvement in output density and energy density of a battery.

Also in such an all-solid-state lithium secondary battery, it is important to prevent a short circuit between the positive electrode and the negative electrode in order to enhance the reliability of the battery. Here, as a technique for preventing a short circuit between positive and negative electrodes, for example, WO 2018/110688 A discloses a technique in which in an all-solid-state lithium secondary battery including a positive electrode current collector, a negative electrode current collector, and a powder laminate disposed between the positive electrode current collector and the negative electrode current collector, the powder laminate includes a positive electrode powder layer, a negative electrode powder layer, and a solid electrolyte layer disposed between the positive electrode powder layer and the negative electrode powder layer and covering outer peripheries of the positive electrode powder layer and the negative electrode powder layer. According to WO 2018/110688 A, by adopting such a configuration, a short circuit between the positive and negative electrodes can be effectively prevented.

### SUMMARY OF INVENTION

### Technical Problem

However, according to the study of the present inventors, it has been found that in the case of using the technique described in WO 2018/110688 A, particularly when the solid electrolyte layer covers the positive electrode active material layer and extends to the positive electrode current collector, peeling may occur between the solid electrolyte layer and the positive electrode current collector.

Therefore, an object of the present invention is to provide a means capable of suppressing occurrence of peeling between a solid electrolyte layer and a positive electrode current collector in a lithium secondary battery including the solid electrolyte layer covering an outer side of a positive electrode active material layer and extending to the positive electrode current collector.

### Solution to Problem

The present inventors have conducted intensive studies to solve the above problem. As a result, they have found that in a lithium secondary battery including a solid electrolyte layer covering an outer side of a positive electrode active material layer, the above problem can be solved by using a positive electrode current collector in which a composite elastic modulus value of a main surface on a side of the positive electrode active material layer is a predetermined value or less, and have completed the present invention.

That is, one aspect of the present invention relates to a lithium secondary battery including a power generating element including: a positive electrode in which a positive electrode active material layer is disposed on a surface of a positive electrode current collector, a negative electrode, and a solid electrolyte layer intervening between the positive electrode and the negative electrode and containing a solid electrolyte. In the lithium secondary battery, the solid electrolyte layer extends to the positive electrode current collector so as to cover at least a part of a side surface of the positive electrode active material layer, and a composite elastic modulus value as measured by a spherical nanoindentation method for a main surface of the positive electrode current collector on a side of the positive electrode active material layer is 17.0 [GPa] or less.

### BRIEF DESCRIPTION OF DRAWINGS

FIG. 1 is a cross-sectional view schematically illustrating an overall structure of a laminate type (internal parallel connection type) all-solid-state lithium secondary battery (laminate type secondary battery) as one embodiment of the present invention.

FIG. 2 is an enlarged cross-sectional view of a single battery layer of a laminate type secondary battery according to one embodiment of the present invention.

FIG. 3 is a perspective view of the laminate type secondary battery according to one embodiment of the present invention.

FIG. 4 is a side view as viewed from direction A illustrated in FIG. 3.

FIG. 5 is an enlarged cross-sectional view of a single battery layer of a laminate type secondary battery according to another embodiment of the present invention.

### DESCRIPTION OF EMBODIMENTS

One aspect of the present invention is a lithium secondary battery including a power generating element including: a positive electrode in which a positive electrode active material layer is disposed on a surface of a positive electrode current collector, a negative electrode, and a solid electrolyte layer intervening between the positive electrode and the negative electrode and containing a solid electrolyte, wherein the solid electrolyte layer extends to the positive electrode current collector so as to cover at least a part of a side surface of the positive electrode active material layer, and a composite elastic modulus value as measured by a spherical nanoindentation method for a main surface of the positive electrode current collector on a side of the positive electrode active material layer is 17.0 [GPa] or less. With the configuration according to the present aspect, occurrence of peeling between a solid electrolyte layer and a positive electrode current collector is suppressed in a lithium secondary battery including the solid electrolyte layer covering an outer side of a positive electrode active material layer and extending to the positive electrode current collector. This can contribute to improvement in cycle durability and the like of the battery. By realizing an integrated structure of the positive electrode current collector, the positive electrode active material layer, and the solid electrolyte layer, the handleability of the solid electrolyte layer, which is usually brittle, can be improved, and the time and cost required for the production process can be reduced.

Hereinafter, the present aspect will be described with reference to the drawings, but the technical scope of the present invention should be determined based on the description of the claims, and is not limited to the following aspects. Dimensional ratios in the drawings are exaggerated for convenience of description, and may be different from actual ratios.

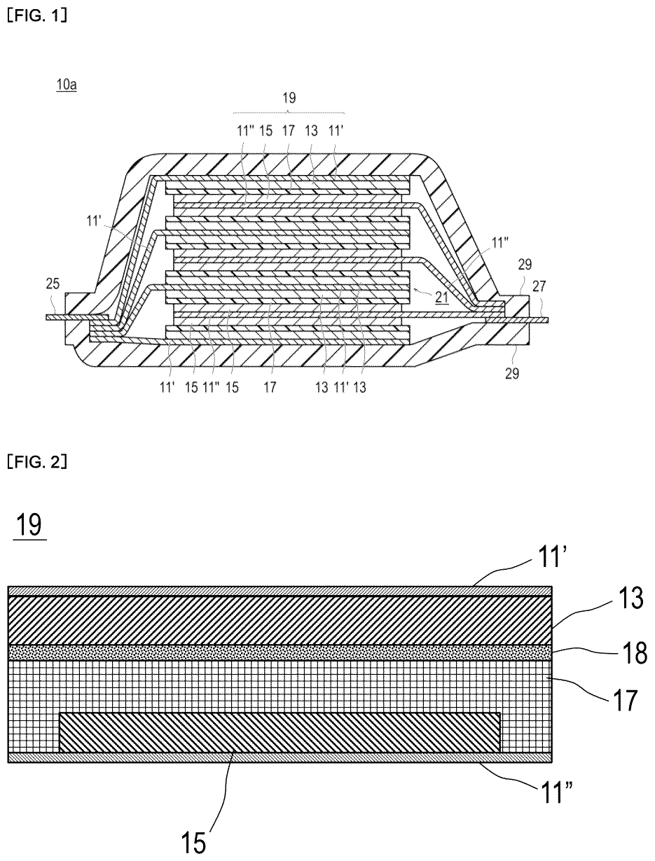

FIG. 1 is a cross-sectional view schematically illustrating an overall structure of a laminate type (internal parallel connection type) all-solid-state lithium secondary battery (hereinafter, also simply referred to as “laminate type secondary battery”) as one embodiment of the present invention. A laminate type secondary battery 10a illustrated in FIG. 1 has a structure in which a power generating element 21 having a substantially rectangular shape in which a charge-discharge reaction actually proceeds is sealed inside a laminate film 29 as a battery outer casing body. FIG. 1 illustrates a cross section of the laminate type secondary battery after charging, and thus a negative electrode active material layer 13 made of lithium metal is present between a negative electrode current collector 11′ and a solid electrolyte layer 17. A confining pressure is applied to the laminate type secondary battery 10a in a lamination direction of the power generating element 21 by a pressurizing member (not illustrated). Therefore, the volume of the power generating element 21 is kept constant.

As illustrated in FIG. 1, the power generating element 21 of the laminate type secondary battery 10a of the present aspect has a configuration in which a negative electrode where the negative electrode active material layer 13 containing lithium metal is disposed on both surfaces of the negative electrode current collector 11′, the solid electrolyte layer 17, and a positive electrode where a positive electrode active material layer 15 containing a lithium transition metal composite oxide is disposed on both surfaces of a positive electrode current collector 11″ are laminated. Specifically, the negative electrode, the solid electrolyte layer, and the positive electrode are laminated in this order such that one negative electrode active material layer 13 and the positive electrode active material layer 15 adjacent thereto face each other with the solid electrolyte layer 17 interposed therebetween. Thereby, the negative electrode, the solid electrolyte layer, and the positive electrode that are adjacent constitute one single battery layer 19. Therefore, it can be said that the laminate type secondary battery 10a illustrated in FIG. 1 has a configuration in which a plurality of single battery layers 19 are laminated to be electrically connected in parallel.

The negative electrode current collector 11′ and the positive electrode current collector 11″ have a structure in which a negative electrode current collecting plate 25 and a positive electrode current collecting plate 27 which are electrically connected to the respective electrodes (the negative electrode and the positive electrode) are respectively attached to the negative electrode current collector 11′ and the positive electrode current collector 11″ and are led to an outside of the laminate film 29 so as to be sandwiched between end parts of the laminate film 29. The negative electrode current collecting plate 25 and the positive electrode current collecting plate 27 may be attached to the negative electrode current collector 11′ and the positive electrode current collector 11″ of the respective electrodes with a negative electrode terminal lead and a positive electrode terminal lead (not illustrated) interposed therebetween, respectively by ultrasonic welding, resistance welding, or the like as necessary.

In the above description, one embodiment of the lithium secondary battery according to one aspect of the present invention has been described by taking the laminate type (internal parallel connection type) all-solid-state lithium secondary battery, which is a so-called lithium-deposition type in which lithium metal is deposited on the surface of the negative electrode current collector during charging, as an example. However, the type of the lithium secondary battery to which the present invention can be applied is not particularly limited, and the present invention can also be applied to a lithium secondary battery, which is not a lithium-deposition type, and a bipolar lithium secondary battery.

FIG. 2 is an enlarged cross-sectional view of the single battery layer 19 of a laminate type secondary battery according to one embodiment of the present invention. As illustrated in FIG. 2, the single battery layer 19 constituting the laminate type secondary battery 10a according to the present embodiment has a positive electrode including the positive electrode current collector 11″ and the positive electrode active material layer 15 disposed on the surface of the positive electrode current collector 11″. The solid electrolyte layer 17 containing a solid electrolyte is disposed on the surface of the positive electrode active material layer 15 on a side opposite to the positive electrode current collector 11″. In the embodiment illustrated in FIG. 2, the solid electrolyte layer 17 extends to reach the positive electrode current collector 11″ so as to cover the entire outer periphery of the positive electrode active material layer 15. In the embodiment illustrated in FIG. 2, a carbon black layer 18 containing carbon black nanoparticles is provided in a region including the entire region, where the positive electrode active material layer 15 faces the negative electrode current collector 11′, of the main surface of the solid electrolyte layer 17 facing the negative electrode current collector 11′ (in other words, in a slightly larger size than the positive electrode active material layer 15 when the power generating element 21 is viewed in plan view). Carbon black constituting this carbon black layer 18 has lithium-ion conductivity, so that the carbon black layer 18 can conduct lithium ions. Therefore, the progression of the battery reaction is not hindered by disposing the carbon black layer 18. This carbon black layer 18 also has a function of suppressing a reaction between lithium metal (negative electrode active material layer 13) deposited on the negative electrode current collector 11′ during charging and the solid electrolyte contained in the solid electrolyte layer 17. Therefore, it can be said that the carbon black layer 18 functions as an ion-conductive reaction suppression layer.

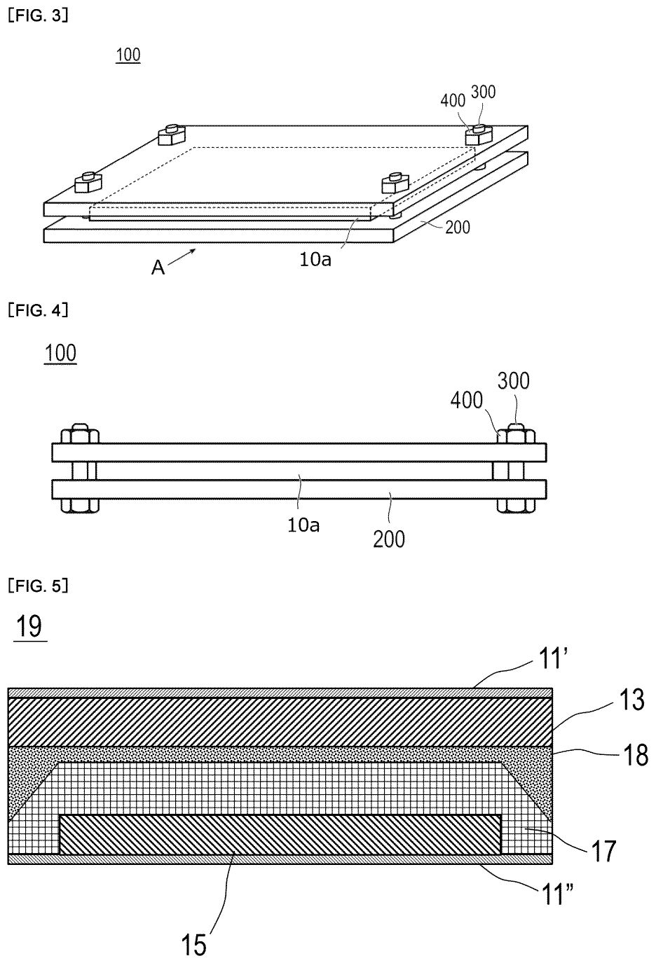

FIG. 3 is a perspective view of the laminate type secondary battery according to one embodiment of the present invention. FIG. 4 is a side view as viewed from direction A illustrated in FIG. 3. As illustrated in FIGS. 3 and 4, a laminate type secondary battery 100 according to the present embodiment includes the laminate type secondary battery 10a illustrated in FIG. 1, two metal plates 200 sandwiching the laminate type secondary battery 10a, and bolts 300 and nuts 400 as fastening members. The fastening members (the bolts 300 and the nuts 400) have a function of fixing the laminate type secondary battery 10a in a state where the metal plates 200 sandwich the laminate type secondary battery 10a. Thereby, the metal plates 200 and the fastening members (the bolts 300 and the nuts 400) function as pressurizing members that pressurize (confine) the laminate type secondary battery 10a in the lamination direction thereof. The pressurizing member is not particularly limited as long as it is a member that can pressurize the laminate type secondary battery 10a in the lamination direction thereof. Typically, a combination of a plate formed of a material having rigidity like the metal plates 200 and the above-described fastening member is used as the pressurizing member. As the fastening member, not only the bolts 300 and the nuts 400 but also a tension plate or the like that fixes the end part of the metal plates 200 so as to confine the laminate type secondary battery 10a in the lamination direction thereof may be used.

The lower limit of the load applied to the laminate type secondary battery 10a (confining pressure in the lamination direction of the laminate type secondary battery) is, for example, 0.1 MPa or more, preferably 1 MPa or more, more preferably 3 MPa or more, and further preferably 5 MPa or more. The upper limit of the confining pressure in the lamination direction of the laminate type secondary battery is, for example, 100 MPa or less, preferably 70 MPa or less, more preferably 40 MPa or less, and further preferably 10 MPa or less.

Hereinafter, main components of the laminate type secondary battery 10a described above will be described.

### [Positive Electrode Current Collector]

The positive electrode current collector is a conductive member that functions as a flow path for electrons emitted from a positive electrode toward a power source along with the progression of the charge reaction or flowing from an external load toward the positive electrode along with the progression of the discharge reaction.

The positive electrode current collector used in the lithium secondary battery according to the present aspect is characterized in that the composite elastic modulus value as measured by a spherical nanoindentation method for the main surface on the side of the positive electrode active material layer is 17.0 [GPa] or less. With such a configuration, occurrence of peeling between a solid electrolyte layer and a positive electrode current collector is suppressed in a lithium secondary battery including the solid electrolyte layer covering an outer side of a positive electrode active material layer and extending to the positive electrode current collector. This is considered to be because when the positive electrode current collector and the solid electrolyte layer are bonded to each other with the positive electrode active material layer sandwiched therebetween during production of the lithium secondary battery, a material constituting the solid electrolyte layer easily bites into the positive electrode current collector having a small composite elastic modulus value, and adhesion between the positive electrode current collector and the solid electrolyte layer is improved.

The composite elastic modulus value may be 17.0 [GPa] or less, and from the viewpoint of preventing occurrence of peeling, the smaller this value is more preferable. Specifically, the composite elastic modulus value is preferably 15.0 [GPa] or less, more preferably 13.0 [GPa] or less, further preferably 11.0 [GPa] or less, further preferably 10.2 [GPa] or less, still more preferably 9.0 [GPa] or less, particularly preferably 5.0 [GPa] or less, and most preferably 1.0 [GPa] or less. On the other hand, from the viewpoint of the strength and handleability of the positive electrode current collector itself, the composite elastic modulus value is preferably 0.5 [GPa] or more. That is, in a preferred embodiment, the composite elastic modulus value is 0.5 to 17.0 [GPa]. As the composite elastic modulus value of the positive electrode current collector, a value measured by the method described in the section of Examples described later is adopted.

The material constituting the positive electrode current collector is not particularly limited as long as the composite elastic modulus value of the main surface on the side of the positive electrode active material layer is within the above range. Examples of the constituent material of the positive electrode current collector include a metal and a resin having conductivity (such as a resin obtained by adding a conductive filler to a non-conductive polymer material), the main surface of the positive electrode current collector on the side of the positive electrode active material layer is preferably composed of an inorganic material such as a metal or a carbon material, and the entire positive electrode current collector is more preferably composed of an inorganic material such as a metal or a carbon material. Among them, the constituent material of the positive electrode current collector is preferably an etched aluminum foil in which the main surface on the side of the positive electrode active material layer is etched, a carbon-coated aluminum foil in which the main surface on the side of the positive electrode active material layer is coated with a carbon material, a roughened aluminum foil in which the main surface on the side of the positive electrode active material layer is roughened, or a carbon foil. As these constituent materials, materials subjected to etching treatment, coating with a carbon material, roughening treatment, or the like may be purchased and used, or those obtained by subjecting materials, which are not subjected to these treatments, to these treatments by themselves may be used. The current collector may have a single-layer structure made of a single material, or may have a laminated structure in which layers made of the above-described materials are appropriately combined. The thickness of the positive electrode current collector is not particularly limited, but is, for example, 10 to 100 μm.

### [Positive Electrode Active Material Layer]

The positive electrode constituting the lithium secondary battery according to the present aspect has a positive electrode active material layer containing a positive electrode active material. The positive electrode active material layer 15 is disposed on the surface of the positive electrode current collector 11″ as illustrated in FIG. 1.

The positive electrode active material is not particularly limited as long as it is a material that can release lithium ions in the charging process of the secondary battery and can occlude lithium ions in the discharging process. An example of such a positive electrode active material includes a material containing an M1 element and an O element, and the M1 element includes at least one element selected from the group consisting of Li, Mn, Ni, Co, Cr, Fe, and P. Examples of such a positive electrode active material include layered rock salt-type active materials such as LiCoO₂, LiMnO₂, LiNiO₂, and Li(Ni—Mn—Co)O₂, spinel-type active materials such as LiMn₂O₄ and LiNi_{0.5}Mn_{1.5}O₄, olivine-type active materials such as LiFePO₄ and LiMnPO₄, Si-containing active materials such as Li₂FeSiO₄ and Li₂MnSiO₄, and the like. Examples of the oxide active material other than those described above include Li₄Ti₅O₁₂ and LiVO₂. In some cases, two or more kinds of positive electrode active materials may be used in combination. Needless to say, a positive electrode active material other than the above-described positive electrode active materials may be used. In a preferred embodiment, the positive electrode active material layer 15 constituting the lithium secondary battery according to the present aspect contains a layered rock salt-type active material (for example, Li(Ni—Mn—Co)O₂) containing lithium and cobalt as a positive electrode active material from the viewpoint of output characteristics.

Examples of the shape of the positive electrode active material include a particulate shape (spherical and fibrous shapes), a thin film shape, and the like. When the positive electrode active material is particulate, the average particle size (D50) thereof is preferably within a range of 1 nm to 100 μm, more preferably within a range of 10 nm to 50 μm, further preferably within a range of 100 nm to 20 μm, and particularly preferably within a range of 1 to 20 μm. In the present specification, the value of the average particle size (D50) of the positive electrode active material can be measured by a laser diffraction scattering method.

The content of the positive electrode active material in the positive electrode active material layer is not particularly limited, but for example, is preferably within a range of 30 to 99 mass %, more preferably within a range of 40 to 90 mass %, further preferably within a range of 45 to 80 mass %.

In the lithium secondary battery according to the present aspect, the positive electrode active material layer 15 preferably further contains a solid electrolyte. In the present specification, the solid electrolyte refers to a material mainly made of an ion conductor that enables ion conduction in a solid, and particularly refers to a material having a degree of lithium-ion conductivity at a normal temperature (25° C.) of 1×10⁻⁵ S/cm or more, and the degree of lithium-ion conductivity thereof is 1×10⁻⁴ S/cm or more. Here, a value of the degree of ionic conductivity can be measured by an AC impedance method.

Examples of the solid electrolyte include a sulfide solid electrolyte and an oxide solid electrolyte. In a preferred embodiment of the lithium secondary battery according to the present aspect, the solid electrolyte is preferably a sulfide solid electrolyte containing an S element, more preferably a sulfide solid electrolyte containing a Li element, an M element, and an S element, where the M element includes at least one element selected from the group consisting of P, Si, Ge, Sn, Ti, Zr, Nb, Al, Sb, Br, Cl, and I, and further preferably a sulfide solid electrolyte containing an S element, a Li element, and a P element, from the viewpoint of exhibiting excellent lithium-ion conductivity and being capable of further following the volume change of the electrode active material associated with charging and discharging.

The sulfide solid electrolyte may have a Li₃PS₄ skeleton, a Li₄P₂S₇ skeleton, or a Li₄P₂S₆ skeleton. Examples of the sulfide solid electrolyte having a Li₃PS₄ skeleton include LiI—Li₃PS₄, LiI—LiBr—Li₃PS₄, and Li₃PS₄. Examples of the sulfide solid electrolyte having a Li₄P₂S₇ skeleton include a Li—P—S-based solid electrolyte called LPS. As the sulfide solid electrolyte, for example, LGPS represented by Li₍₄₋ₓ₎Ge₍₁₋ₓ₎PₓS₄ (x satisfies 0<x<1) or the like may be used. More specifically, examples thereof include LPS (Li₂S—P₂S₅), Li₇P₃S₁₁, Li_{3.2}P_{0.96}S, Li_{3.25}Ge_{0.25}P_{0.75}S₄, Li₁₀GeP₂S₁₂, Li₆PS₅X (where X is Cl, Br, or I), and the like. The description of “Li₂S—P₂S₅” means a sulfide solid electrolyte obtained by using a raw material composition containing Li₂S and P₂S₅, and the same applies to other descriptions. Above all, the sulfide solid electrolyte has high ion conductivity and low volume modulus, and thus is preferably selected from the group consisting of LPS (Li₂S—P₂S₅), Li₆PS₅X (where X is Cl, Br, or I), Li₇P₃S₁₁, Li_{3.2}P_{0.96}S, and Li₃PS₄, from the viewpoint of capable of further following the volume change of the electrode active material associated with charging and discharging.

The content of the solid electrolyte in the positive electrode active material layer is not particularly limited, but for example, is preferably within a range of 1 to 70 mass %, more preferably within a range of 10 to 60 mass %, further preferably within a range of 20 to 55 mass %.

The positive electrode active material layer may further contain at least one of a conductive aid and a binder in addition to the positive electrode active material and the solid electrolyte. The thickness of the positive electrode active material layer varies depending on the configuration of the intended lithium secondary battery, but is, for example, preferably within a range of 0.1 to 1000 μm, and more preferably 40 to 100 μm.

### [Solid Electrolyte Layer]

The solid electrolyte layer is a layer intervening between the positive electrode and the negative electrode and contains a solid electrolyte (usually as a main component). Since the specific form of the solid electrolyte contained in the solid electrolyte layer is the same as that described above, the detailed description thereof is omitted here. The content of the solid electrolyte in the solid electrolyte layer is, for example, preferably within a range of 10 to 100 mass %, more preferably within a range of 50 to 100 mass %, further preferably within a range of 90 to 100 mass %, with respect to the total mass of the solid electrolyte layer. The solid electrolyte layer may further contain a binder in addition to the solid electrolyte described above. The thickness of the solid electrolyte layer varies depending on the configuration of the intended lithium secondary battery, but is, for example, preferably within a range of 0.1 to 1000 μm, and more preferably 10 to 40 μm.

### [Negative Electrode Current Collector]

The negative electrode current collector is a conductive member that functions as a flow path for electrons emitted from a negative electrode toward an external load along with the progression of the discharge reaction or flowing from a power source toward the negative electrode along with the progression of the charge reaction. A material constituting the negative electrode current collector is not particularly limited. As a constituent material of the negative electrode current collector, for example, a metal or a resin having conductivity can be adopted. The thickness of the negative electrode current collector is not particularly limited, but is, for example, 10 to 100 μm.

### [Negative Electrode Active Material Layer]

The negative electrode constituting the lithium secondary battery according to the present aspect has a negative electrode active material layer containing a negative electrode active material. The negative electrode active material layer 13 is disposed on the surface of the negative electrode current collector 11′ as illustrated in FIG. 1.

The specific type of the negative electrode active material is not particularly limited. An example of such a negative electrode active material includes a carbon material, a metal oxide, and a metal active material. As the negative electrode active material, a metal containing lithium may be used. Such a negative electrode active material is not particularly limited as long as it is an active material containing lithium, and examples thereof include lithium-containing alloys in addition to metal lithium. Examples of the lithium-containing alloys include an alloy of Li and at least one of In, Al, Si, Sn, Mg, Au, Ag, and Zn. The negative electrode active material preferably contains metal lithium or a lithium-containing alloy, a silicon-based negative electrode active material, or a tin-based negative electrode active material, and particularly preferably contains metal lithium or a lithium-containing alloy. When the negative electrode active material uses metal lithium or a lithium-containing alloy, the lithium secondary battery according to the present aspect may be a so-called lithium-deposition type in which lithium metal as a negative electrode active material is deposited on a negative electrode current collector in a charging process. Therefore, in such an embodiment, the thickness of the negative electrode active material layer increases with the progression of the charging process, and the thickness of the negative electrode active material layer decreases with the progression of the discharging process. The negative electrode active material layer may not be present when the battery has been completely discharged, but in some cases, a negative electrode active material layer made of a certain amount of lithium metal may be disposed when the battery has been completely discharged.

The content of the negative electrode active material in the negative electrode active material layer is not particularly limited, but for example, is preferably within a range of 40 to 100 mass %, and more preferably within a range of 50 to 90 mass %.

The negative electrode active material layer may further contain a solid electrolyte as necessary. When the negative electrode active material layer contains the solid electrolyte, the ion conductivity of the negative electrode active material layer can be improved. Since the specific form of the solid electrolyte contained in the negative electrode active material layer is the same as that described above, the detailed description thereof is omitted here.

The content of the solid electrolyte in the negative electrode active material layer is, for example, preferably within a range of 1 to 60 mass % and more preferably within a range of 10 to 50 mass %.

The negative electrode active material layer may further contain at least one of a binder and a conductive aid in addition to the negative electrode active material and the solid electrolyte described above. The thickness of the negative electrode active material layer varies depending on the configuration of the intended secondary battery, but is, for example, preferably within a range of 0.1 to 1000 μm, and more preferably 40 to 100 μm.

### [Ion-Conductive Reaction Suppression Layer (Negative Electrode Intermediate Layer)]

In the lithium secondary battery according to the present aspect, an ion-conductive reaction suppression layer (also referred to as “negative electrode intermediate layer”) is preferably provided on at least a part of a region, where the positive electrode active material layer faces the negative electrode current collector, of a main surface of the solid electrolyte layer facing the negative electrode current collector. This ion-conductive reaction suppression layer is a layer having lithium-ion conductivity and inhibiting a reaction between lithium metal (negative electrode active material layer) and a solid electrolyte. Therefore, by providing the ion-conductive reaction suppression layer, it is possible to prevent deterioration of the solid electrolyte and a decrease in battery capacity caused by the reaction between the lithium metal (negative electrode active material layer) and the solid electrolyte without hindering the progression of the battery reaction. The degree of lithium-ion conductivity of the constituent material of the ion-conductive reaction suppression layer at 25° C. is preferably 1×10⁻⁴ [S/cm] or more, more preferably 1.5×10⁻⁴ [S/cm] or more, further preferably 2.0×10⁻⁴ [S/cm] or more, particularly preferably 2.5×10⁻⁴ [S/cm] or more, and most preferably 3.0×10⁻⁴ [S/cm] or more.

The constituent material of the ion-conductive reaction suppression layer is not particularly limited, and various materials capable of expressing the above-described function can be employed. Examples of the constituent material of the ion-conductive reaction suppression layer include nanoparticles having lithium-ion conductivity. When the ion-conductive reaction suppression layer contains the nanoparticles, a lithium secondary battery having a particularly excellent function of the ion-conductive reaction suppression layer can be provided. Here, the “nanoparticles” mean particles having an average particle size on a scale of nanometers (nm). The “average particle size” of nanoparticles refers to a 50% cumulative diameter (D50) with respect to a particle size (maximum distance among distances between any two points on the contour line of the observed particle) measured by observing a cross-section of a layer containing nanoparticles with a scanning electron microscope (SEM). The average particle size of the nanoparticles is preferably 500 nm or less, more preferably 300 nm or less, further preferably 150 nm or less, particularly preferably 100 nm or less, and most preferably 60 nm or less. In particular, when the average particle size of the nanoparticles is 60 nm or less, a lithium secondary battery particularly excellent in the effect of suppressing the growth of dendrites can be provided. The lower limit value of the average particle size of the nanoparticles is not particularly limited, but is usually 10 nm or more and preferably 20 nm or more.

Such nanoparticles preferably contain, for example, one or two or more elements selected from the group consisting of carbon, gold, platinum, palladium, silicon, silver, aluminum, bismuth, tin, and zinc, more preferably contain one or two or more of elementary substances or alloys of these elements, further preferably contain an elementary substance of carbon or silver, and particularly preferably contain an elementary substance of carbon and silver, from the viewpoint of being particularly excellent in the function as the ion-conductive reaction suppression layer. Examples of the material composed of the elementary substance of carbon include acetylene black, Vulcan (registered trademark), Black Pearl (registered trademark), carbon nanofiber, Ketjen Black (registered trademark), carbon nanotube, carbon nanohorn, carbon nanoballoon, fullerene, and the like. When the ion-conductive reaction suppression layer contains such nanoparticles, the layer may further contain a binder.

The average thickness of the ion-conductive reaction suppression layer is not particularly limited. The average thickness of the ion-conductive reaction suppression layer is preferably 300 nm to 20 μm, more preferably 500 nm to 15 μm, and further preferably 1 to 10 μm when this layer is a layer containing first nanoparticles. The “average thickness” of the protective layer means a value calculated as an arithmetic average value of thicknesses measured at several to several tens of different points in the ion-conductive reaction suppression layer constituting the lithium secondary battery.

### [Positive Electrode Current Collecting Plate and Negative Electrode Current Collecting Plate]

A material constituting the current collecting plates (25 and 27) is not particularly limited, and a known highly conductive material conventionally used as a current collecting plate for a secondary battery can be used. As a constituent material of the current collecting plate, for example, a metal material such as aluminum, carbon-coated aluminum, copper, titanium, nickel, stainless steel (SUS), or an alloy thereof is preferable. From the viewpoint of weight reduction, corrosion resistance, and high conductivity, aluminum and copper are more preferable, and aluminum is particularly preferable. The same material or different materials may be used for the negative electrode current collecting plate 25 and the positive electrode current collecting plate 27.

In the above description, the laminated structure and arrangement form of the laminate type secondary battery 10a (lithium secondary battery) according to the embodiment illustrated in FIG. 2 have been described as an example, but the lithium secondary battery according to the present aspect can adopt various laminated structures and arrangement forms of each layer other than this. Examples of such other embodiments include the embodiment illustrated in FIG. 5. In the embodiment illustrated in FIG. 5, the outer peripheral end of the solid electrolyte layer 17 covering the side surface of the positive electrode active material layer 15 is disposed in a tapered shape with respect to the side surface of the positive electrode active material layer 15. According to such a configuration, it is possible to suppress the current from concentrating on the outer peripheral edge portion of the positive electrode active material layer 15 at the time of charging and discharging, it is also possible to suppress the deterioration of the active material layer and the generation of dendrite, and it is possible to prevent deterioration of cycle durability caused by these.

Although a case where the secondary battery according to the present aspect is an all-solid-state lithium secondary battery is described as an example, the lithium secondary battery according to the present aspect may not be an all-solid type. That is, the solid electrolyte layer may further contain a conventionally known liquid electrolyte (electrolyte solution). The amount of the liquid electrolyte (electrolyte solution) that can be contained in the solid electrolyte layer is not particularly limited, but is preferably such an amount that the shape of the solid electrolyte layer formed by the solid electrolyte is maintained and liquid leakage of the liquid electrolyte (electrolyte solution) does not occur. As the liquid electrolyte (electrolyte solution), a solution containing a conventionally known lithium salt dissolved in a conventionally known organic solvent is used. The liquid electrolyte (electrolyte solution) may further contain an additive other than the organic solvent and the lithium salt. These additives may be used singly or in combination of two or more kinds thereof. The amount of the additive used in the electrolyte solution can be appropriately adjusted.

According to another aspect of the present invention, a positive electrode-solid electrolyte layer laminate which is a constituent member of the lithium secondary battery according to one aspect of the present invention described above is also provided. The laminate includes a positive electrode current collector, a positive electrode active material layer, and a solid electrolyte layer laminated in the stated order, the solid electrolyte layer extends to the positive electrode current collector so as to cover at least a part of a side surface of the positive electrode active material layer, and a composite elastic modulus value as measured by a spherical nanoindentation method for a main surface of the positive electrode current collector on a side of the positive electrode active material layer is 17.0 [GPa] or less. Since the configuration of each member of the laminate is as described above, the detailed description thereof will be omitted here.

According to still another aspect of the present invention, a method for producing the above-described positive electrode-solid electrolyte layer laminate is also provided. The producing method is characterized by including bonding the positive electrode current collector and the solid electrolyte layer constituting the laminate to each other by roll pressing or cold isostatic pressing (CIP) with the positive electrode active material layer sandwiched therebetween. A bonding method using roll pressing or cold isostatic pressing (CIP) is known per se, and a laminate in a favorable bonding state can be produced regardless of which is used. From the viewpoint of excellent handleability, it is preferable to perform bonding by roll pressing. The temperature at the time of roll pressing is not particularly limited, but is usually about 10 to 250° C. The linear pressure at the time of roll pressing is also not limited, and is usually about 0.5 to 10 ton/cm. From the viewpoint of further suppressing the occurrence of cracks in the solid electrolyte layer, it is preferable to perform bonding by CIP. In particular, when bonding is performed by CIP under high temperature conditions such as 30° C. or higher, preferably 50° C. or higher, more preferably 80° C. or higher, the occurrence of cracks in the solid electrolyte layer can be remarkably suppressed. The upper limit of the temperature at the time of CIP is not limited, but is usually 100° C. or lower. The pressure at the time of CIP is also not limited, and is usually about 200 to 800 MPa, preferably 400 to 600 MPa.

The following embodiments are also included in the scope of the present invention: the lithium secondary battery according to claim 1 having the feature of claim 2; the lithium secondary battery according to claim 1 or 2 having the feature of claim 3; the lithium secondary battery according to any one of claims 1 to 3 having the feature of claim 4; the lithium secondary battery according to claim 4 having the feature of claim 5; the positive electrode-solid electrolyte layer laminate used for the lithium secondary battery according to any one of claims 1 to 5 having the feature of claim 6; and the method for producing the positive electrode-solid electrolyte layer laminate according to claim 6 having the feature of claim 7.

### EXAMPLES

Hereinafter, the present invention will be described in more detail with reference to Experimental Examples. However, the technical scope of the present invention is not limited only to the following Experimental Examples. Hereinafter, the operation was performed in a glove box. The instruments, devices, and the like used in the glove box were sufficiently dried in advance.

[Preparation of Positive Electrode Active Material Layer]

First, LiNi_{0.5}Mn_{0.1}Co_{0.1}O₂ as a positive electrode active material, acetylene black as a conductive aid, and argyrodite (Li₆PS₅Cl) having an average particle size of 1 μm as a sulfide solid electrolyte were weighed to have a mass ratio of 60:10:30, these materials were mixed using an agate mortar. To 100 parts by mass of the obtained mixed powder, 2 parts by mass of PTFE as a binder was added, and the resulting mixture was lightly kneaded, and then kneaded in a mortar for 2 minutes while a shear force was applied.

The mixture thus obtained was molded using a hand roller and stretched to a thickness of 200 μm. Thereafter, a positive electrode active material layer (thickness: 70 μm) was finally produced through a tabletop roll press.

### [Preparation of Laminate of Positive Electrode Active Material Layer and Positive Electrode Current Collector]

A carbon-coated aluminum foil was prepared as a positive electrode current collector. The composite elastic modulus of the main surface of the positive electrode current collector (carbon-coated aluminum foil) was measured by the following method, and found to be 0.65 [GPa].

### (Method of Measuring Composite Elastic Modulus of Positive Electrode Current Collector)

The composite elastic modulus was measured by a spherical nanoindentation method using a nanoindenter “TI980” manufactured by Hysitron as a measurement device under an environment of 25° C. As the measurement indenter, a spherical diamond indenter having an indenter tip radius of 10 μm was used. The measurement conditions were as follows.
Measurement mode: load-unload test
Maximum indentation depth: 4000 nm
Retention time when maximum load is reached: 0 seconds
Load speed and unloading speed: 800 nm/sec

In the measurement, the positive electrode current collector for measuring the composite elastic modulus was fixed to a glass substrate with an adhesive, and then fixed to a sample stage with a vacuum chuck. The relationship between the indentation depth and the indentation load was measured under the measurement conditions described above, and the relationship between the indentation strain and the average contact pressure was determined from the obtained measurement value (stress-strain curve). From the slope of the stress-strain curve thus obtained, the composite elastic modulus Eᵣ at the time of pushing was calculated based on the Hertz contact solution. The Hertz contact solution is expressed by the following formula. The measurement was performed at six different points for one sample, and the arithmetic average value was used as the measured value.

### Hertz Contact Solution

$$P = 4 / 3 {E}_{r} {R}^{1 / 2} {h}^{3 / 2}$$

In the formula, P denotes the indentation load [mN], Eᵣ denotes the composite elastic modulus [GPa], R denotes the indenter tip radius [μm], and h is the indentation depth [nm].

Next, the positive electrode active material layer produced above was punched into a size of 20 mm×20 mm (corner R=1 mm). On the other hand, the positive electrode current collector prepared above was punched into a size of 25 mm×25 mm (corner R=1 mm). Then, the punched positive electrode active material layer was disposed at the center of the punched positive electrode current collector, and pressed under an environment of 25° C. using a roll press machine so as to apply a linear pressure of 1 ton/cm, thereby preparing a laminate of the positive electrode active material layer and the positive electrode current collector.

### [Preparation of Laminate of Solid Electrolyte Layer/Positive Electrode Active Material Layer/Positive Electrode Current Collector]

Styrene-butadiene rubber (SBR) as a binder was dissolved in mesitylene as a solvent to prepare a binder solution having a concentration of 5 mass %. On the other hand, argyrodite (Li₆PS₅Cl) having an average particle size of 3 μm as a sulfide solid electrolyte was dissolved in mesitylene as a solvent to prepare a solid electrolyte solution. These solutions were mixed to prepare a solid electrolyte slurry (solid content concentration: 47 mass %, solid electrolyte binder=95:5 (mass ratio)).

Subsequently, the solid electrolyte slurry prepared above was applied onto the surface of a support made of a stainless steel (SUS430) foil so as to have a basis weight of 7.4 mg/cm² using an applicator. Thereafter, the solvent (mesitylene) was removed by drying on a hot plate at 80° C. for 10 minutes to prepare a solid electrolyte layer sheet.

The solid electrolyte layer sheet prepared above was punched into a size of 25 mm×25 mm (corner R=1 mm). Next, the punched solid electrolyte layer sheet was disposed at the center of the surface on the side of the positive electrode active material layer of the laminate of the positive electrode active material layer and the positive electrode current collector prepared above, and the support (stainless steel foil) was peeled off.

The laminate thus obtained was placed in a pack made of an aluminum laminate of 35 mm×35 mm, and the pack was sealed using a vacuum sealer. The pack was subjected to isostatic pressing (CIP) under the conditions of 80° C. and 500 MPa for 1 minute to prepare a laminate of solid electrolyte layer/positive electrode active material layer/positive electrode current collector. The thickness of the solid electrolyte layer in the laminate was 20 μm.

The pack was opened, the laminate was taken out, and the bonding state between the solid electrolyte layer and the positive electrode current collector was visually observed, and as a result, the bonding state was favorable.

### [Experimental Examples Using Various Positive Electrode Current Collectors]

A laminate of solid electrolyte layer/positive electrode active material layer/positive electrode current collector was prepared by the same method as described above using a commercially available positive electrode current collector made of the following materials and having the following composite elastic modulus (units are all [GPa]), and the bonding state between the solid electrolyte layer and the positive electrode current collector was observed. As a result, when a favorable bonding state was confirmed, the composite elastic modulus value was underlined (the results of the above Experimental Examples are also described).
Carbon-coated aluminum foil (composite elastic modulus: 0.65)
Etched aluminum foil (1) (composite elastic modulus: 9.07, 30CB, manufactured by JAPAN CAPACITOR INDUSTRIAL CO., LTD.)
Etched aluminum foil (2) (composite elastic modulus: 9.39, 20CB, manufactured by JAPAN CAPACITOR INDUSTRIAL CO., LTD.)
Etched aluminum foil (3) (composite elastic modulus: 10.14, 20CB054, manufactured by JAPAN CAPACITOR INDUSTRIAL CO., LTD.)
Aluminum foil (composite elastic modulus: 25.35)
Copper foil (composite elastic modulus: 53.35)
Stainless steel (SUS430) foil (composite elastic modulus: 59.25)
Nickel foil (composite elastic modulus: 89.42)

As described above, in the laminate using the carbon-coated aluminum foil and the etched aluminum foil in which the composite elastic modulus value was 17.0 [GPa] or less, the bonding state between the solid electrolyte layer and the positive electrode current collector was favorable. On the other hand, in the laminate using the aluminum foil, the copper foil, the stainless steel foil, and the nickel foil in which the composite elastic modulus value was more than 17.0 [GPa], it was confirmed that the bonding state between the solid electrolyte layer and the positive electrode current collector was poor, and peeling occurred between the solid electrolyte layer and the positive electrode current collector to make the solid electrolyte layer self-standing.

From the above description, with the configuration of the lithium secondary battery according to one aspect of the present invention, occurrence of peeling between a solid electrolyte layer and a positive electrode current collector is suppressed in a lithium secondary battery including the solid electrolyte layer covering an outer side of a positive electrode active material layer and extending to the positive electrode current collector. This can contribute to improvement in cycle durability and the like of the battery.

### REFERENCE SIGNS LIST

10a, 100 Laminate type secondary battery
11′ Negative electrode current collector
11″ Positive electrode current collector
13 Negative electrode active material layer
15 Positive electrode active material layer
17 Solid electrolyte layer
18 Carbon black layer (ion-conductive reaction suppression layer)
19 Single battery layer
21 Power generating element
25 Negative electrode current collecting plate
27 Positive electrode current collecting plate
29 Laminate film
200 Metal plate
300 Bolt
400 Nut

1. A lithium secondary battery comprising a power generating element including:
a positive electrode in which a positive electrode active material layer is disposed on a surface of a positive electrode current collector,
a negative electrode, and
a solid electrolyte layer intervening between the positive electrode and the negative electrode and containing a solid electrolyte, wherein
the solid electrolyte layer extends to the positive electrode current collector so as to cover at least a part of a side surface of the positive electrode active material layer, and
a composite elastic modulus value as measured by a spherical nanoindentation method for a main surface of the positive electrode current collector on a side of the positive electrode active material layer is 17.0 [GPa] or less.

2. The lithium secondary battery according to claim 1, wherein an outer peripheral end of the solid electrolyte layer covering the side surface of the positive electrode active material layer is disposed in a tapered shape with respect to the side surface of the positive electrode active material layer.

3. The lithium secondary battery according to claim 1, wherein the composite elastic modulus value is 0.5 to 17.0 [GPa].

4. The lithium secondary battery according to claim 1, wherein the main surface of the positive electrode current collector on the side of the positive electrode active material layer is made of an inorganic material.

5. The lithium secondary battery according to claim 4, wherein a constituent material of the positive electrode current collector is an etched aluminum foil, a carbon-coated aluminum foil, a roughened aluminum foil, or a carbon foil.

6. A positive electrode-solid electrolyte layer laminate used for the lithium secondary battery according to claim 1,
the positive electrode-solid electrolyte layer laminate comprising the positive electrode current collector, the positive electrode active material layer, and the solid electrolyte layer laminated in a stated order, wherein
the solid electrolyte layer extends to the positive electrode current collector so as to cover at least a part of a side surface of the positive electrode active material layer, and
a composite elastic modulus value as measured by a spherical nanoindentation method for a main surface of the positive electrode current collector on a side of the positive electrode active material layer is 17.0 [GPa] or less.

7. A method for producing the positive electrode-solid electrolyte layer laminate according to claim 6, the method for producing comprising:
bonding the positive electrode current collector and the solid electrolyte layer to each other by roll pressing or cold isostatic pressing (CIP) with the positive electrode active material layer sandwiched therebetween.
